(19) United States
(12) Patent Application Publication
(10) Pub. No.: US 2016/0114474 A1
(43) Pub. Date: Apr. 28, 2016

(54) SAWBUCK

(71) Applicant: David A. Nordgren, Westboro, WI (US)

(72) Inventor: David A. Nordgren, Westboro, WI (US)

(21) Appl. No.: 14/545,258

(22) Filed: Apr. 13, 2015

Related U.S. Application Data
(60) Provisional application No. 62/122,506, filed on Oct. 22, 2014.

(51) Int. Cl. B25H 1/06

(52) U.S. Cl. CPC B25H 1/06

(57) ABSTRACT

An article of manufacture for use in combination with stakes driven into the ground to produce a sawbuck, the article of manufacture having an elongated body and an arm, the elongated body having a passageway thereinto in the same direction as the longitudinal axis of the body, the arm attached to the body near the entrance of the passageway, the angle between the longitudinal axis of the arm at the region of the arm where the arm is attached to the tubing and the longitudinal axis of the body being less than sixty degrees. A method of combining the articles with stakes to produce a sawbuck for cross-cutting a length of wood into shorter lengths of wood.

### BACKGROUND OF THE INVENTION

The instant invention is in the field of sawbucks. A sawbuck is a device for holding lengths of wood so that the wood can be crosscut into pieces. The classic sawbuck comprises two or more X shaped vertical structures connected by one or more horizontal beams as disclosed, for example, in U.S. Pat. No. 5,289,897. Sawbucks exemplified by the '879 patent are useful but are not especially portable or easily stored. Another type of sawbuck is a device that holds one end of a length of wood in a cantilever manner as disclosed, for example, in U.S. Pat. No. 4,468,018. Sawbucks exemplified by the '018 patent are not useful to cut longer length of wood because of the flexibility of the free end of a long length of wood held at the other end. Still another type of sawbuck is a device that binds lengths of wood balanced in a central cradle as disclosed, for example, in U.S. Pat. No. 4,566,559. Sawbucks exemplified by the '559 patent are cumbersome to use because of the binding means used to secure the wood. It would be an advance in the art of sawbucks if an article of manufacture were discovered that could be easily stored and transported to a job site, which article of manufacture would be a component of a sawbuck in combination with stakes driven into the ground.

### SUMMARY OF THE INVENTION

The instant invention is the discovery of an article of manufacture that is easily stored and transported to a job site, which article of manufacture is a component of a sawbuck in combination with stakes driven into the ground. More specifically, the instant invention is an article of manufacture comprising: an elongated body and an arm, the elongated body having a passageway thereinto in the same direction as the longitudinal axis of the body, the arm attached to the body, the angle between the longitudinal axis of the arm at the region of the arm where the arm is attached to the tubing and the longitudinal axis of the body being less than sixty degrees.

In another embodiment, the instant invention is method for cross-cutting lengths of wood into shorter lengths of wood, comprising the steps of: (a) vertically driving at least two stakes into ground so that the top of the stakes are about at the same height and about in line; (b) positioning an article of manufacture of claim 1 on each stake with the stake extending into the passageway; (c) positioning a length of wood in the intersection of the body and the arm of each article of manufacture of the preceding paragraph; (d) cross cutting the length of wood at a position between one end of the length of wood and one of the articles of manufacture of claim 1; (e) cross cutting the length of wood at a position between the other end of the length of wood and another of the articles of manufacture of claims 1; and (0 cross cutting the length of wood at a position between the at least two articles of manufacture of the preceding paragraph.

### BRIEF DESCRIPTION OF THE DRAWINGS

FIG. 1 is a side view partly in cross-section and partly in full of a highly preferred article of manufacture of the instant invention positioned on a stake and holding lengths of wood; and

FIG. 2 is a rear view in full of three articles of manufacture of the instant invention positioned on stakes driven into the ground and holding lengths of wood.

### DETAILED DESCRIPTION OF THE INVENTION

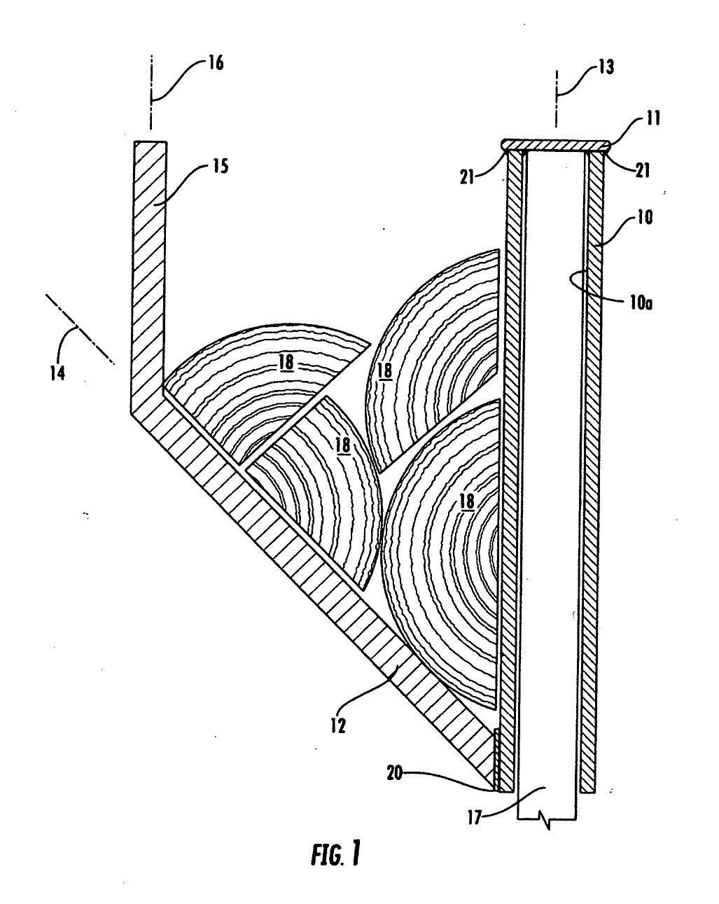

Referring now to FIG. 1 therein is shown a side view, partly in cross-section and partly in full, of a highly preferred article of manufacture of the instant invention positioned on a stake 17 and holding lengths of wood 18. The article of manufacture comprises an elongated body in the shape of a length of tubing 10, a cap 11 and an arm 12. The tubing 10 can be round, square or other shape but preferably the tubing 10 is square shaped. The tubing 10 can be of any appropriate material but preferably the tubing 10 is steel tubing. The cap 11 can be of any appropriate material but preferably the cap 11 is made of steel and welded to the tubing 10 to cap the tubing 10 by welding 21. It should be understood that any means can be used to cap the tubing 10. For example, the tubing 10 can be capped by positioning a bolt through the tubing 10, by a threaded pipe cap or by crimping the tubing 10 and that such means are within the scope of the instant invention to produce an elongated body having a passageway thereinto, exemplified in FIG. 1 by the passageway 10a. The arm 12 can be of any appropriate material but preferably the arm 12 is steel angle iron or a section of steel fence stake welded to the tubing 10 by welding 20. The angle between the longitudinal axis 14 of the arm 12 at the region of the arm where the arm is attached to the tubing and the longitudinal axis 13 of the tubing should be less than sixty degrees so that the wood 18 is held securely between the arm 12 and the tube 10 when cross cut into pieces. Most preferably the angle between the longitudinal axis 14 of the arm 12 at the region of the arm where the arm is attached to the tubing and the longitudinal axis 13 of the tubing is less than or equal to forty-five degrees. Preferably the arm 12 is bent so that the longitudinal axis 16 of a distal end portion 15 of the arm 12 is parallel with the longitudinal axis 13 of the tubing 10. It should be understood that the article of manufacture of the instant invention can be formed as an integral unit and that such is within the scope of the instant disclosure. For example, the article of manufacture of the instant invention can be formed of reinforced plastic by the injection molding process.

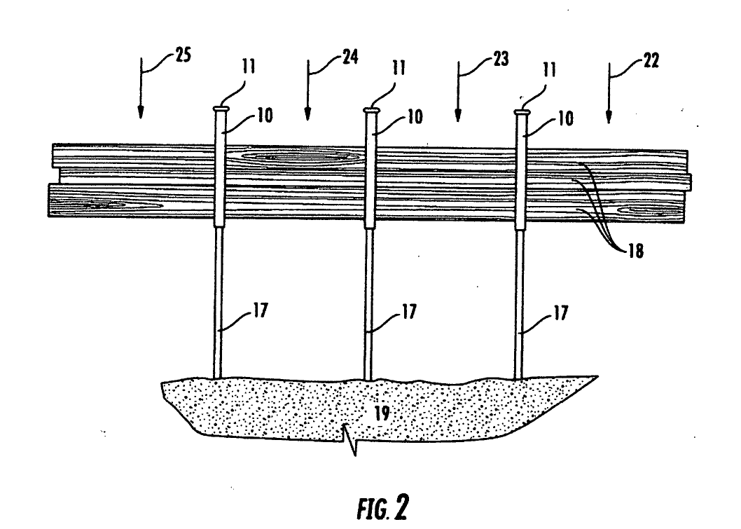

Referring now to FIG. 2, therein is shown a rear view in full of three articles of manufacture of the instant invention of FIG. 1 positioned on stakes 17 driven into the ground 19 and holding lengths of wood 18. It should be understood that although three articles of manufacture of the instant invention are shown in FIG. 2, such number is not critical in the instant invention. Thus, any plurality of such articles can be used. The stakes 17 are preferably steel fence stakes. Referring still to FIG. 2, the arrows 22, 25, 24 and 23 indicate the direction and sequence of cutting the wood 18 according to the method of the instant invention.

An important benefit of the instant invention is the ease of set-up, take-down and storage. For example, if it is desired to cut a truck load of slab wood into firewood, then a line of stakes can be driven into the ground near the truck, the articles of manufacture of the instant invention can then be positioned on the stakes to produce a sawbuck and the wood positioned thereon to be cut into pieces.

Another important benefit of the instant invention relates to the upright body position of the person doing the sawing with, for example, a chain saw, by positioning the wood to be cut at a relatively high level (in contrast to the often bent over position of the person doing the sawing with a conventional sawbuck). When the job of cutting the wood is completed, the sawbuck made possible by the instant invention can then be dismantled and conveniently moved to a new job site or compactly stored for future use.

### CONCLUSION

While the instant invention has been described above and claimed below according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. An article of manufacture for use in combination with stakes driven into the ground to produce a sawbuck, the article of manufacture comprising: an elongated body and an arm, the elongated body having a passageway thereinto in the same direction as the longitudinal axis of the body, the arm attached to the body, the angle between the longitudinal axis of the arm at the region of the arm where the arm is attached to the tubing and the longitudinal axis of the body being less than sixty degrees.

2. The article of manufacture of claim 1, wherein the arm is bent so that the longitudinal axis of a distal end portion of the arm is about parallel with the longitudinal axis of the body.

3. The article of manufacture of claim 1, wherein the angle between the longitudinal axis of the arm at the region of the arm where the arm is attached to the tubing and the longitudinal axis of the body is less than or equal to forty-five degrees.

4. The article of manufacture of claim 2, wherein the angle between the longitudinal axis of the arm at the region of the arm where the arm is attached to the tubing and the longitudinal axis of the body is less than or equal to forty-five degrees.

5. A method for cross-cutting lengths of wood into shorter lengths of wood, comprising the steps of: (a) vertically driving at least two stakes into ground so that the top of the stakes are about at the same height and about in line; (b) positioning an article of manufacture of claim 1 on each stake with the stake extending into the passageway; (c) positioning a length of wood in the intersection of the body and the arm of each article of manufacture of claim 1 so that the wood extends at the ends thereof away from each article of manufacture of claim 1; (d) cross cutting the length of wood at a position between one end of the length of wood and one of the articles of manufacture of claim 1; (e) cross cutting the length of wood at a position between the other end of the length of wood and the other article of manufacture of claim 1; and (f) cross cutting the length of wood at a position between the at least two articles of manufacture of claim 1.

6. A method for cross-cutting lengths of wood into shorter lengths of wood, comprising the steps of: (a) vertically driving at least two stakes into ground so that the top of the stakes are about at the same height and in line; (b) positioning an article of manufacture of claim 2 on each stake with the stake extending into the passageway; (c) positioning a length of wood in the intersection of the body and the arm of each article of manufacture of claim 2 so that the wood extends at the ends thereof away from each article of manufacture of claim 2; (d) cross cutting the length of wood at a position between one end of the length of wood and one of the articles of manufacture of claim 2; (e) cross cutting the length of wood at a position between the other end of the length of wood and the other article of manufacture of claim 2; and (f) cross cutting the length of wood at a position between the at least two articles of manufacture of claim 2.
